(19) United States
(12) Patent Application Publication
(10) Pub. No.: US 2004/0204075 A1
(43) Pub. Date: Oct. 14, 2004

(54) Wireless transceiver module and system employing a wireless transceiver apparatus between a portable communicating device and a communication network

(76) Inventors: Mark Frederick Rusnak, North Huntingdon, PA (US); Joseph Charles Engel, Monroeville, PA (US); Charles John Luebke, Sussex, WI (US); Stephen Thomas Troemel, Grandville, MI (US)

Correspondence Address: Martin J. Moran, Cutler-Hammer, Technology & Quality Center, RIDC Park West, 170 Industry Drive, Pittsburgh, PA, 15275-1032, US

(21) Appl. No.: 10/157,772

(22) Filed: May 29, 2002

(51) Int. Cl. H04B 1/38

(52) U.S. Cl. 455/557; 455/550.1; 455/556.1

(57) ABSTRACT

A wireless transceiver module includes a wireless transceiver communicating with a portable communicating device, such as a personal digital assistant, through a wireless port. An interface is provided to a communication network, such as an INCOM network or a CH-Wire network, for a plurality of control and distribution electrical devices having a plurality of electrical parameters. A processor includes routines for monitoring and configuring the electrical parameters of the electrical devices from the portable communicating device through the wireless port.

### BACKGROUND OF THE INVENTION

1. Field of the Invention

The present invention relates to communication apparatus and systems and, in particular, to such apparatus and systems employing wireless communications and, more particularly, to such apparatus and systems communicating with communicating devices having parameters, such as electrical communicating devices having electrical parameters.

2. Background Information

User configuration of electrical equipment (e.g., a circuit breaker trip unit) has historically employed manual controls (e.g., rotary or pushbutton switches, a keyboard, dial potentiometers, displays) to permit a user to establish initial operational settings or to change existing settings to new settings.

In other user configuration implementations, where sufficient space is not available for such manual controls, a handheld configuration or programming device is employed to electrically connect the electrical equipment through a cable of wires. This allows the uploading of, for example, current settings to the handheld device, modification of those settings, and the subsequent download of new settings.

In both of these configuration implementations, the user initially establishes the setting values or, else, changes existing values by selecting new values at each piece of electrical equipment. However, these same values are not saved and then recalled for later re-use at another piece of electrical equipment. In order to refer to settings at another time or location, the operator has to record the values for later reference.

Typically, most modern electrical equipment operates under the control of a program burned into one or more programmable read-only memory (PROM) chips. In turn, program updates involve the removal of the old memory chip and the installation of a new memory chip using a socket on the equipment's printed circuit board.

It is known to employ On-Board Programming (OBP) through a Joint Test Action Group Test Access Port (JTAG TAP) (IEEE 1149.1). Communication with a JTAG-compliant device is accomplished by employing a hardware controller that either inserts into a PC add-in card slot or by using a stand-alone programmer. The controller connects to a JTAG-compliant PCB. The JTAG-compliant device connects to all flash memory address, data and control signals. The JTAG hardware controller sends commands and data to the JTAG-compliant device, which propagates the data to the flash memory for programming. The JTAG hardware controller provides a communication link with any JTAG-compliant device.

It is believed, from an operator standpoint, that prior known methods of interfacing with electrical equipment have, most likely, at some time resulted in the operator having an insecure feeling about being suitably electrically isolated from such equipment during the configuration process.

The INCOM (INdustrial COMmunications) Network provides two-way communication between an INCOM network master and a variety of products such as, for example, electrical interrupting devices, circuit breakers, digital meters, motor overload relays, monitoring units and a wide range of industrial products. Control and monitoring is carried out over a network consisting of dedicated twisted pair wires. Preferably, a semi-custom integrated circuit provides a simple, low cost interface to the network. For example, a Sure Chip Plus™ microcontroller enables the electrical interrupting device to communicate with the INCOM network. This integrated circuit provides various network functions such as, for example, carrier generation and detection, data modulation/demodulation, address decoding, and generation and checking of a 5-bit cyclic redundant BCH error code.

An INCOM communication module, which may be otherwise known as a PONI “Product Operated Network Interface,” may act as an interface device between a remote personal computer PC and the electrical meter, protector or control communicating device that does not have a built-in INCOM transceiver.

The INCOM network employs a simple two-wire asynchronous communication line, which is daisy chained to the several devices. A master device digitally addresses each of the slave devices in a master/slave relationship for the purpose of gathering the data generated by the individual units for central processing. An INCOM network can have one master and up to 1000 slaves. The INCOM communications protocol is based on 33-bit message packets. A typical INCOM network transaction consists of one or more 33-bit message packets transmitted by the master, and one or more 33-bit message packets transmitted by a slave in response.

Examples of the INCOM network and protocol are disclosed in U.S. Pat. Nos. 4,644,547; 4,644,566; 4,653,073; 5,315,531; 5,548,523; 5,627,716; 5,815,364; and 6,055,145, which are incorporated by reference herein.

There are two basic types of INCOM messages: control messages and data messages. The messages are 33 bits in length and are sent with the Least Significant Bit (LSB) first. The INCOM chip generates a number of the bits including the Start bits, Stop bit and BCH error detection code. The format for an INCOM-control message is shown in Table 1.

TABLE 1

| Bit Number(s) | Mnemonic | Definition |
|---|---|---|
| 1-0 | STR | Start Bits = 11 |
| 2 | C/D | Control Bit = 1 for Control Messages |
| 6-3 | INST | Instruction Field |
| 10-7 | COMM | Command Field |
| 22-11 | ADDRESS | Address of Product (Slave Device) |
| 26-23 | SCOMM | SubCommand Field |
| 31-27 | BCH | BCH error detection field |
| 32 | STP | Stop Bit = 0 |

The format for an INCOM-Data message is shown in Table 2.

TABLE 2

| Bit Number(s) | Mnemonic | Definition |
|---|---|---|
| 1-0 | STR | Start Bits = 11 |
| 2 | C/D | Control Bit = 0 for Data Messages |
| 10-3 | BYTE0 | 8-bit data field (Bit 3 = b0) |
| 18-11 | BYTE1 | 8-bit data field (Bit 11 = b0) |
| 26-19 | BYTE2 | 8-bit data field (Bit 18 = b0) |
| 31-27 | BCH | BCH error detection field |
| 32 | STP | Stop Bit = 0 |

There are two types of INCOM slave devices (products): a stand-alone slave, and an expanded mode slave. The stand-alone slave is a device on an INCOM network that can control one digital output and monitor up to two status (digital) inputs. An example of a stand-alone slave device is an addressable relay marketed by Eaton/Cutler-Hammer of Pittsburgh, Pa. A stand-alone slave device uses INCOM control messages exclusively for communications.

The expanded mode slave is a device on an INCOM network that can send and/or receive data values over the INCOM network including, for example, analog and digital I/O data, configuration or setpoint information, and trip data. Examples of such devices include IQ Data Plus II Line Metering Systems, Digitrip RMS 700 and 800 Trip Units, and IQ 1000 and IQ 500 Motor Protection Systems, all marketed by Eaton/Cutler-Hammer. An expanded mode slave device uses INCOM control messages and INCOM data messages for communications.

There are seven examples in which an expanded mode slave product, in response to a command from the master, may send a return-command message to the master. These include: (1) Acknowledge (ACK) Reply; (2) Negative Acknowledge (NACK) Reply; (3) Product Buffer Not Yet Available; (4) Sub-network Product Not Responding; (5) Checksum Error; (6) Downloaded Value Out of Range; and (7) Product Not in a State That Allows the Requested Action.

Some INCOM commands require the product to transmit an acknowledge (ACK) message. The positive acknowledge indicates that the product accepted the present command or the data transmission was completed successfully. The format of the ACK message, ignoring the Start bits, Stop bit and BCH error detection code, includes: (1) C/D=1; (2) INST=3; (3) COMM=1; (4) ADDRESS=address of slave (some products may employ address 000H or FFFH; other products can assume any address in the 12 bit address space); and (5) SCOMM=0. The product will transmit a negative acknowledge (NACK), rather than an ACK, in response to certain conditions. The negative acknowledge indicates that the product has not accepted the COMM and SCOMM command request. The format of the NACK message, ignoring the Start bits, Stop bit and BCH error detection code, includes: (1) C/D=1; (2) INST=3; (3) COMM=1; (4) ADDRESS=address of slave (some products may employ address 000H or FFFH; other products can assume any address in the 12 bit address space); and (5) SCOMM=1.

For example, some conditions for which a product will respond with a NACK include: (1) the product received an INCOM control message that it does not recognize (e.g., an INCOM control message with INST=3, and COMM and SCOMM values that it does not support); and (2) the PONI received an INCOM control message that it cannot process due to a communications failure between the PONI and the product. Products only respond to INCOM messages containing a good BCH value.

Examples of standard master-to-slave commands for the Integrated Monitoring, Protection, And Control Communication (IMPACC) protocol are shown below, in Table 3. All of these commands employ C/D=1 and, thus, only the INST, COMM, and SCOMM specifications are provided. The words transmit and receive in the command definitions are with respect to the product. If the message is a transmit command, then the result will be the transmission of data from the product to the master. On the other hand, a receive command that is transmitted from the master to the product will be followed by data transmissions from the master, which are to be received by the product. Table 3 shows six classes of standard master-to-expanded mode slave commands.

TABLE 3

| Command | INST | COMM | SCOMM |
|---|---|---|---|
| Standard slave-buffer transmissions | 3 | 0 | 0-F |
| Standard system management buffer | 3 | A | 3-7 |
| transmissions | | | |
| Product specific slave-buffer transmissions | 3 | C | 8-F |
| Standard slave actions | 3 | D | 0, 1, 3 |
| Standard master-buffer transmissions | 3 | D | 8-F |
| Product specific master-buffer transmissions | 3 | F | 8-F |
| Broadcast Command | D | 0-F | 0-F |

A few examples of these communications data buffers are discussed, below. A standard data buffer includes a specification for the formatting of analog data in engineering units. For example, the IMPACC 24-Bit Floating Point Number Format permits the IMPACC family to include a number of products that send similar analog parameters (e.g., currents, voltages). Each parameter is sent as a single data transmission with the three bytes defined as follows: (1) BYTE0 is the low-order byte of 16-bit magnitude; (2) BYTE1 is the high-order byte of 16-bit magnitude; and (3) BYTE2 is the scale byte, wherein the BYTE2 bit definitions (b7-b0) are as follows: (a) for bit b7: 0 indicates that the value in BYTE0 and BYTE1 is a 16-bit unsigned integer, and 1 indicates that the value in BYTE0 and BYTE1 is a 16-bit signed integer; (b) for bit b6: 0 indicates that the data is invalid, and 1 indicates that the data is valid; (c) for bit b5: 0 indicates a multiplier as a power of 2, and 1 indicates a multiplier as a power of 10, and (d) the bits b4-b0 represent the multiplier's exponent in 5-bit signed integer form. This allows a magnitude of multiplier to range from 2⁻¹⁶ to 2⁺¹⁵ (for b5=0), or 10⁻¹⁶ to 10⁺¹⁵ (for b5=1).

Table 4 shows the Standard Expanded Mode Slave-Buffer Transmissions (for COMM=0 and SCOMM=0-F).

TABLE 4

| INST | COMM | SCOMM | Command Definition |
|---|---|---|---|
| 3 | 0 | 0 | Transmit Fast-Status. |
| 3 | 0 | 3 | Transmit All Standard Buffers |
| 3 | 0 | 5 | Transmit Current Buffer |
| 3 | 0 | 6 | Transmit Line-to-Line Voltage Buffer |
| 3 | 0 | 7 | Transmit Line-to-Neutral Voltage Buffer |
| 3 | 0 | 8 | Transmit Power Buffer(1) |
| 3 | 0 | 9 | Transmit Power Buffer(2) |
| 3 | 0 | A | Transmit Energy Buffer |
| 3 | 0 | B | Transmit Saved Energy Buffer |
| 3 | 0 | C | Transmit Saved Reactive Energy Buffer |
| 3 | 0 | F | Receive Expanded Transmit Buffer |
| | | | Number |

Table 5 shows the Buffer Numbers for the Receive Expanded Transmit Buffer Number command (for COMM=0 and SCOMM=F).

TABLE 5

| Buffer | |
|---|---|
| No. | Buffer Description |
| N = 1 | Transmit Temperature Buffer |
| N = 2 | Transmit Demand Currents Buffer |
| N = 3 | Transmit Current Buffer |
| N = 4 | Transmit Line-Line Voltage Buffer |
| N = 5 | Transmit Line-Neutral Voltage Buffer |
| N = 6 | Transmit Power Buffer |
| N = 7 | Transmit Per-Phase Power Buffer |
| N = 8 | Transmit System Energy Buffer |
| N = 9 | Transmit THD Buffer |
| N = 10 | Transmit Demand Current Buffer (w/ time stamp) |
| N = 11 | Transmit Per-Phase Demand Current Buffer (w/ time stamp) |
| N = 12 | Transmit Demand Power Buffer (w/ time stamp) |
| N = 13 | Transmit Min/Max Current Buffer (w/ time stamp) |
| N = 14 | Transmit Min/Max L-L Voltage Buffer (w/ time stamp) |
| N = 15 | Transmit Min/Max L-N Voltage Buffer (w/ time stamp) |
| N = 16 | Transmit Min/Max PF-Displacement Buffer (w/ time stamp) |
| N = 17 | Transmit Min/Max PF-Apparent Buffer (w/ time stamp) |
| N = 18 | Transmit Min/Max Power/Frequency Buffer (w/ time stamp) |
| N = 19 | Transmit Min/Max Current %THD Buffer (w/ time stamp) |
| N = 20 | Transmit Min/Max Voltage %THD Buffer (w/ time stamp) |
| N = 21 | Transmit Crest Factor Buffer |
| N = 22 | Transmit Min/Max per-phase real power (w/ time stamp) |
| N = 23 | Transmit Min/Max per-phase reactive power (w/ time stamp) |
| N = 24 | Transmit Min/Max per-phase VA (w/ time stamp) |
| N = 25 | Transmit Min/Max Currents Buffer (w/o time stamp) |
| N = 26 | Transmit Demand Currents Buffer (w/o time stamp) |
| N = 27 | Transmit Demand Power Buffer (w/o time stamp) |
| N = 28 | Transmit Min/Max Voltage Buffer (w/o time stamp) |
| N = 29 | Transmit Min/Max Power/Frequency/PF Buffer (w/o time stp.) |
| N = 30 | Transmit Min/Max Current %THD Buffer (w/o time stamp) |
| N = 31 | Transmit Min/Max Voltage %THD Buffer (w/o time stamp) |
| N = 32 | Transmit Min/Max Current THD Magnitude Buf. (w/ time stp.) |
| N = 33 | Transmit Min/Max Voltage THD Magnitude Buf. (w/ time stp.) |
| N = 34 | Transmit Whole Load Center Energy Buffer |

The Transmit All Standard Buffers command definition (3 0 3 of Table 4) covers the standard buffers as defined by INST=3, COMM=0, and SCOMM=5 through A.

The Transmit Current Buffer (3 0 5 of Table 4) response consists of four data messages, each containing an IMPACC 24-bit Floating Point Number, with the current units being expressed in amperes. The four messages respectively include: (1) phase current IA; (2) phase current IB; (3) phase current IC; and (4) current IX, which is usually ground current, although for some products there is no ground current and the current IX may be either a fourth pole current or a neutral current.

The Transmit Line-to-Line Voltage Buffer (3 0 6 of Table 4) response consists of three data messages, each containing an IMPACC 24-bit Floating Point number, with the voltage units being expressed in volts. The three messages respectively include: (1) line-to-line voltage VAB; (2) line-to-line voltage VBC; and (3) line-to-line voltage VCA.

The Transmit Line-to-Neutral Voltage Buffer (3 0 7 of Table 4) response consists of three data messages, each containing an IMPACC 24-bit Floating Point number, with voltage units being expressed in volts. The three messages respectively include: (1) line-to-neutral voltage VAN; (2) line-to-neutral voltage VBN; and (3) line-to-neutral voltage VCN.

The Transmit Expanded Buffer (3 0 F of Table 4) command allows for the use of additional standard responses beyond those covered by INST=3, COMM=0, and SCOMM=3 to E. The Expanded Buffer command consists of the following communications sequence. First, the Master sends the Slave a Transmit Expanded Buffer Number command. Second, the Slave responds with an ACK. Next, the Master sends the Slave a single data message containing the expanded buffer number. Finally, the Slave sends the requested buffer as a series of data messages. The first byte, BYTE0, of the first data message specifies the total number data messages (e.g., up to about 43) to be sent. The expanded buffer number, N, is sent as a 24 bit binary number.

For example, for the Currents Buffer (N=3), there are seven data messages including: (1) Number of additional messages (BYTE0=6); (2) Phase A current; (3) Phase B current; (4) Phase C current; (5) Ground current; (6) Neutral current; and (7) Average phase current.

There is room for improvement in user monitoring and/or configuration of communicating devices, such as electrical communicating devices.

### SUMMARY OF THE INVENTION

These needs and others are met by the present invention, which employs a wireless port to isolate a user at a portable communicating device from a communication network having a plurality of communicating devices.

As one aspect of the invention, a wireless transceiver module comprises: means for communicating with a communication network for a plurality of first communicating devices having a plurality of parameters; means for communicating with a portable second communicating device through a wireless port; and means for monitoring or configuring the parameters of the first communicating devices from the portable second communicating device through the wireless port.

The communication network may be an INCOM network. The communication network may include a gateway having a first RS-232 port, and the means for communicating with a communication network may include a second RS-232 port communicating with the first RS-232 port.

The first communicating devices may include a plurality of trip units.

The parameters may include a plurality of measured electrical values, and the means for monitoring or configuring may include means for monitoring the measured electrical values.

The parameters may include a plurality of setpoint values, and the means for monitoring or configuring may include means for configuring the setpoint values.

The means for monitoring or configuring may include means for controlling the first communicating devices.

As another aspect of the invention, a system for monitoring or configuring communicating devices comprises: a communication network for a plurality of first communicating devices having a plurality of parameters; a portable second communicating device including a first wireless port and a memory storing at least some of the parameters; and a wireless transceiver apparatus comprising: a second wireless port in communication with the portable second communicating device through the first wireless port; an interface to the communication network; and a processor monitoring or configuring the parameters from the portable second communicating device through the first and second wireless ports.

The first communicating devices may be control and distribution devices.

The portable second communicating device may be a personal digital assistant.

The processor may include means for remotely controlling the first communicating devices from the portable second communicating device through the first and second wireless ports.

### BRIEF DESCRIPTION OF THE DRAWINGS

A full understanding of the invention can be gained from the following description of the preferred embodiments when read in conjunction with the accompanying drawings in which:

FIG. 1 is an isometric view of a wireless transceiver module including operational indicators and a window over an infrared transceiver in accordance with the present invention.

FIG. 2 is a block diagram of the wireless transceiver module of FIG. 1, an upper infrared network to a Personal Digital Assistant (PDA), a lower INCOM network to a plurality of electrical equipment devices, and a lower INCOM sub-network to a plurality of electrical equipment devices.

FIG. 3 is a block diagram of a wireless transceiver module, the PDA of FIG. 2, an INCOM network for a plurality of slave electrical equipment devices, and a CH-Wire gateway for a CH-Wire network and a plurality of electrical equipment devices.

FIG. 4 is a block diagram in schematic form of the wireless transceiver module of FIG. 3.

FIGS. 5-14 are representations of display screens of the PDA of FIG. 2.

FIGS. 15, 16A-16C, 17, 18, 19A-19B and 20 are flowcharts of software executed by the PDA application of FIG. 3.

FIGS. 21-24 and 25A-25B are flowcharts of software executed by the wireless transceiver module microcontroller of FIG. 4.

FIG. 26 shows the format of request and response messages between the PDA and the wireless transceiver module of FIG. 3.

### DESCRIPTION OF THE PREFERRED EMBODIMENTS

As employed herein, the term “communication network” shall expressly include, but not be limited to, any local area network (LAN), wide area network (WAN), intranet, extranet, global communication network, wireless communication system or network, and the Internet, which implements any suitable native language network and/or protocol (e.g., without limitation, Integrated Monitoring, Protection, And Control Communication (IMPACC) protocol; INCOM; CH-Wire; Modbus; DeviceNet; Modbus RTU; Multilin marketed by General Electric; DataHighway Plus marketed by Allen-Bradley; BACnet marketed by Alerton Technologies, Inc.; Modbus RTU I/O modules marketed by Arco Mag).

As employed herein, the term “portable communicating device” shall expressly include, but not be limited to, any portable communicating device having a wireless communication port (e.g., a handheld device; a handheld personal computer (PC); a laptop PC; a Personal Digital Assistant (PDA); a mobile or cellular telephone).

As employed herein, the term “communicating device” shall expressly include, but not be limited to, any device, which communicates on a communication network, such as electrical communicating devices (e.g., control and distribution communicating devices); electro-hydraulic communicating sensors, actuators, and/or controls; and electromechanical communicating components (e.g., vehicle transmissions having an interface to a communication network).

As employed herein, the term “parameter” shall expressly include, but not be limited to, any electrical parameter, electro-hydraulic parameter, electro-mechanical parameter, temperature, or speed.

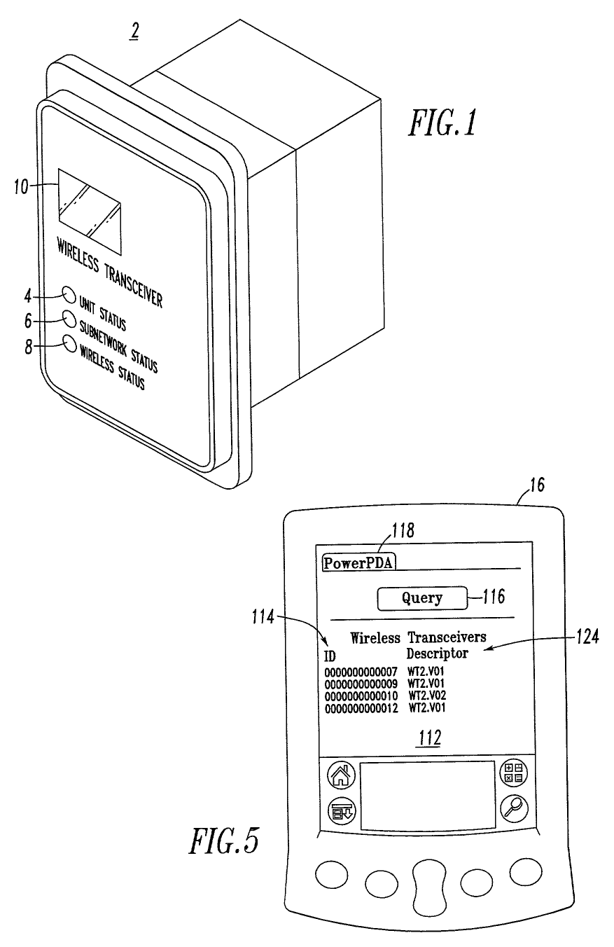

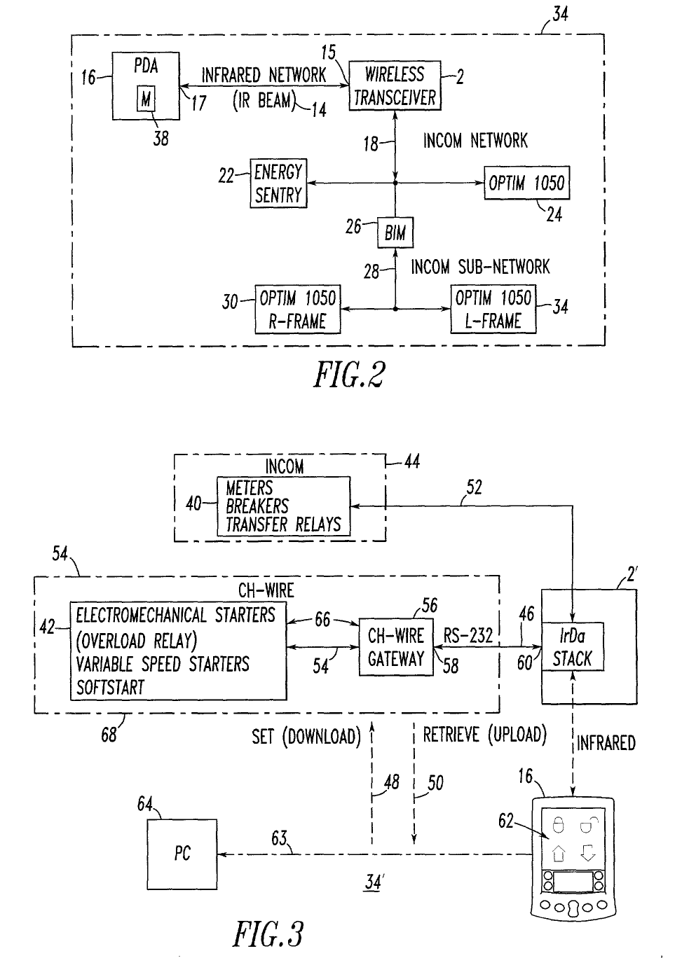

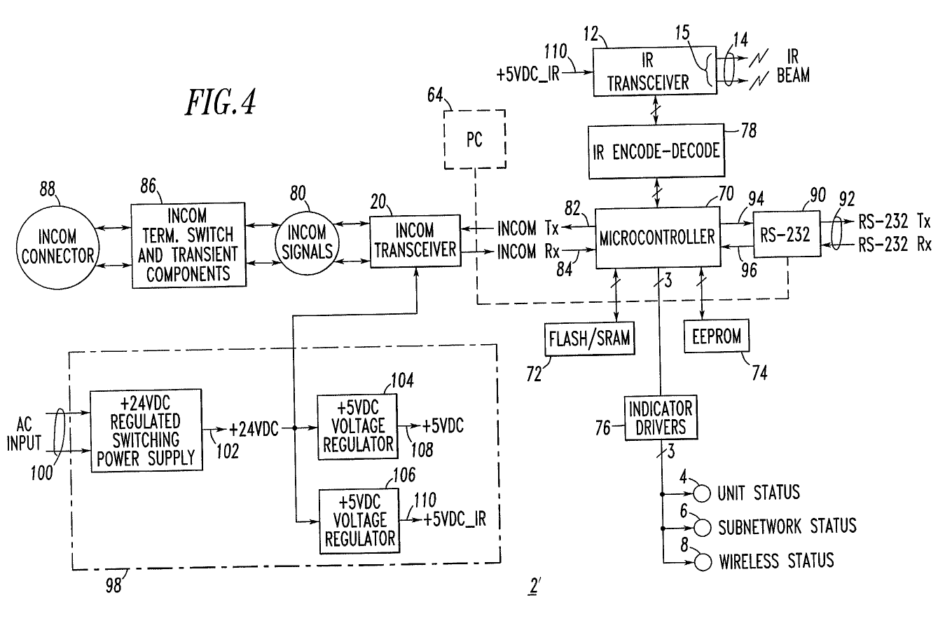

Referring to FIG. 1, a wireless transceiver module 2 includes three operational status indicators (e.g., LEDs) 4,6,8 and a window 10 (e.g., red) over an infrared (IR) transceiver 12 (shown in FIG. 4). The exemplary wireless transceiver module 2 is an InfraRed-Master Incom Network Translator (IR-MINT) module 2. The IR transceiver 12 transmits and receives an infrared beam 14 (shown in FIG. 4) between its wireless port 15 and a Personal Digital Assistant (PDA) 16 (shown in FIG. 2) (e.g., a Palm™ m105 handheld PDA, marketed by Palm, Inc. of Santa Clara, Calif.) including a wireless infrared transceiver module (not shown) having a wireless port 17. Although wireless infrared ports are shown, any suitable wireless port (e.g., radio frequency; IEEE 802.11; Wi-Fi; Bluetooth™; cellular) may be employed.

When power is first applied to the module 2, the Unit Status indicator 4 of FIG. 1 remains ON (e.g., for about four seconds) while the module 2 undergoes a power-up diagnostic test. After the test is successfully completed, the indicator 4 blinks at an exemplary one-half second rate to show that the module 2 is running normally. The Sub-Network (e.g., any network or sub-network which is “below” the module 2) Status indicator 6 blinks when there is, for example, an INCOM transmission between the module 2 and a device connected to the INCOM network 18 (shown in FIG. 2). The Wireless Status indicator 8 is on when there is a transmission between the module 2 and the PDA 16 (shown in FIG. 2). For example, the indicator 8 is active when the module 2 has a connection with the PDA 16 over the infrared link. A connection is established, for example, when a data transfer occurs between the PDA 16 and the module 2 due to a “Get”, “Send” or “Control Action” initiated by the user.

FIG. 2 shows a typical application of the module 2, which includes the infrared transceiver 12 of FIG. 4 for an upper infrared beam linked communication network for the PDA 16, and an INCOM transceiver 20 (shown in FIG. 4) for the lower INCOM network 18. The upper infrared communication network uses the infrared beam 14 for communications between the module 2 and the PDA 16 having an integral infrared port 17. Directly connected to the module 2 is the INCOM network 18, which communicates with electrical monitoring and protection equipment, such as 22,24, using twisted-pair wires. The exemplary INCOM network 18 includes the Energy Sentry 22, the Digitrip Optim 1050 REP trip unit 24, and a Breaker Interface Module (BIM) 26, all of which are marketed by Eaton/Cutler-Hammer of Pittsburgh, Pa. Supported below the BIM 26 is an INCOM sub-network 28 having a Digitrip Optim 1050 “R-Frame” trip unit 30 and a Digitrip Optim 1050 L-Frame trip unit 32. These exemplary trip units 30,32 are also marketed by Eaton/Cutler-Hammer.

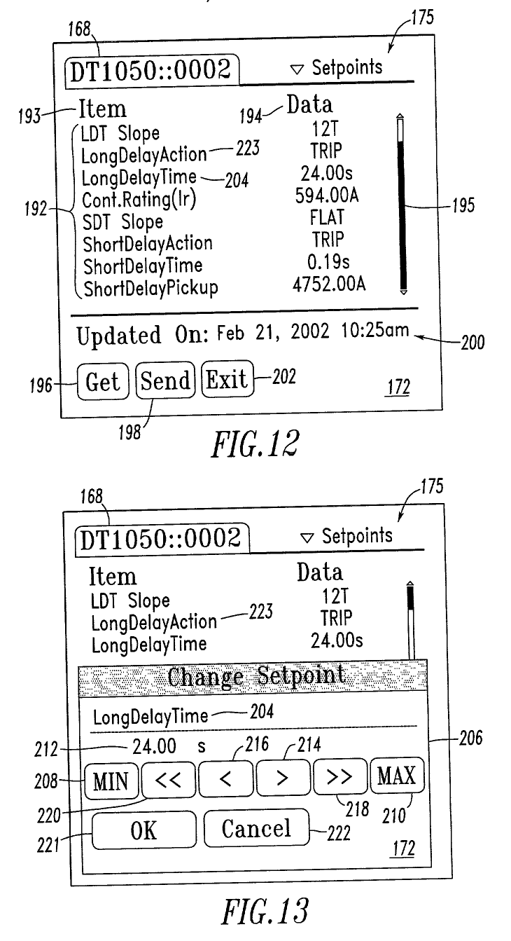

Although exemplary devices 22,24,30,32 and exemplary communication networks 18,28 are shown, the invention is applicable to a wide range of communicating devices having a plurality of parameters, such as control and distribution communicating devices, for a wide range of communication networks (e.g., as shown in FIG. 3). For example, the parameters may include a plurality of measured electrical values (e.g., as shown in FIG. 11) and/or a plurality of setpoint values (e.g., as shown in FIG. 12).

The PDA 16, module 2, networks 18,28, and devices 22,24,26,30,32 form a system 34 for monitoring or configuring such devices. The PDA 16 includes the wireless (e.g., infrared) port 17 and a memory (M) 38 storing one or more of the electrical parameters of such devices.

As shown in FIG. 3, a wireless transceiver module 2′ provides short-range infrared (IR) wireless communication between the handheld PDA device 16 and various control and distribution communicating products 40,42 in system 34′. The module 2′ has two separate sub-network channels 44,46. The INCOM channel 44 communicates with INCOM control and distribution communicating products 40. The RS-232 channel 46 communicates with Eaton/Cutler-Hammer CH-Wire control and distribution communicating products 42. From the PDA 16, the user can perform setpoint and data monitoring, programming, data collection, and remote control functions. The module 2′ receives infrared messages 48 containing an INCOM or CH-Wire message from the PDA 16 and passes the message onto the appropriate product sub-network (e.g., INCOM network 52 or CH-Wire network 54 via a CH-Wire gateway 56). Each of the returning messages to the module 2′ from the products 40,42 is transferred in the transmit infrared messages 50 over the infrared link back to the PDA 16 to be displayed for the user. The module 2′ combines the connection to the control and distribution products 40,42 with the safety of a wireless connection to a user-friendly interface of a standard handheld PDA device 16 (e.g., Palm™ employing the Palm OS™ operating system). The gateway 56 has a first RS-232 port 58 and the module 2′ has a second RS-232 port 60 communicating with the first RS-232 port 58.

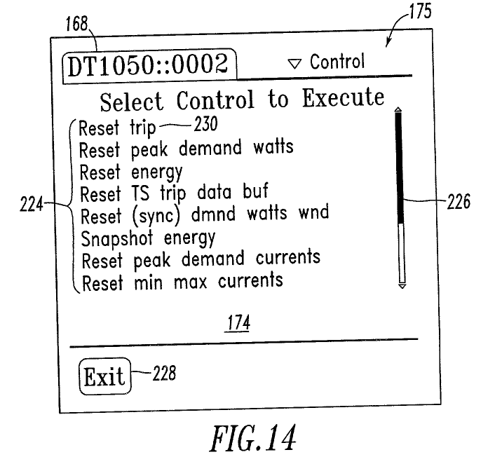

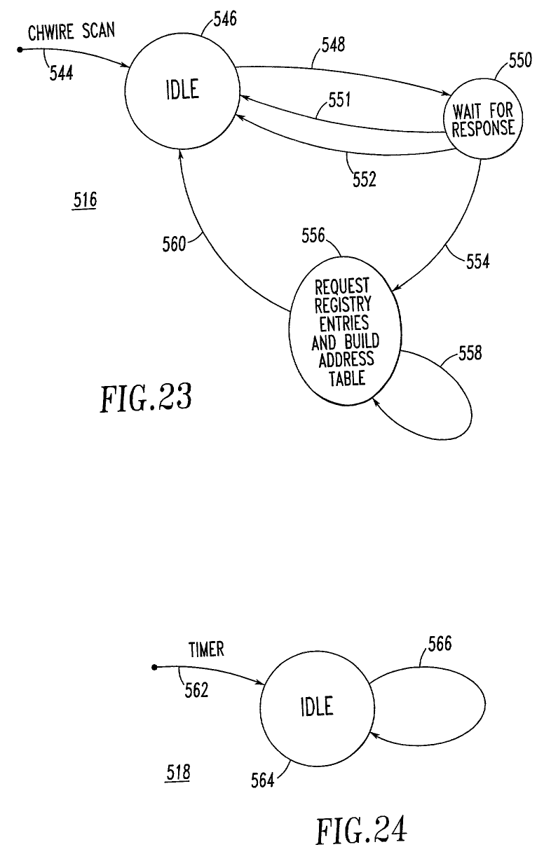

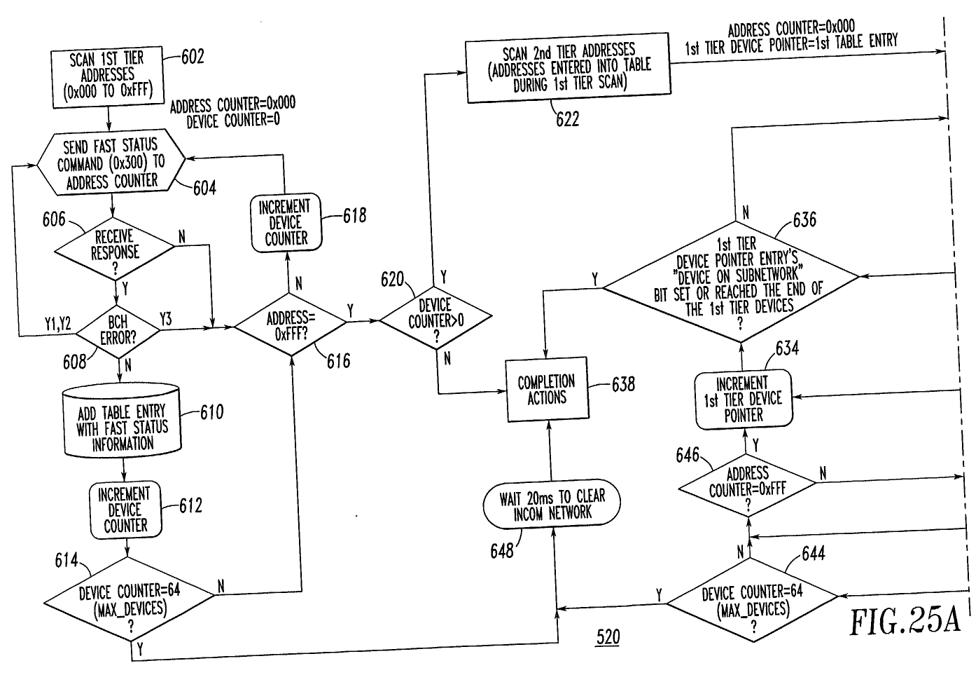

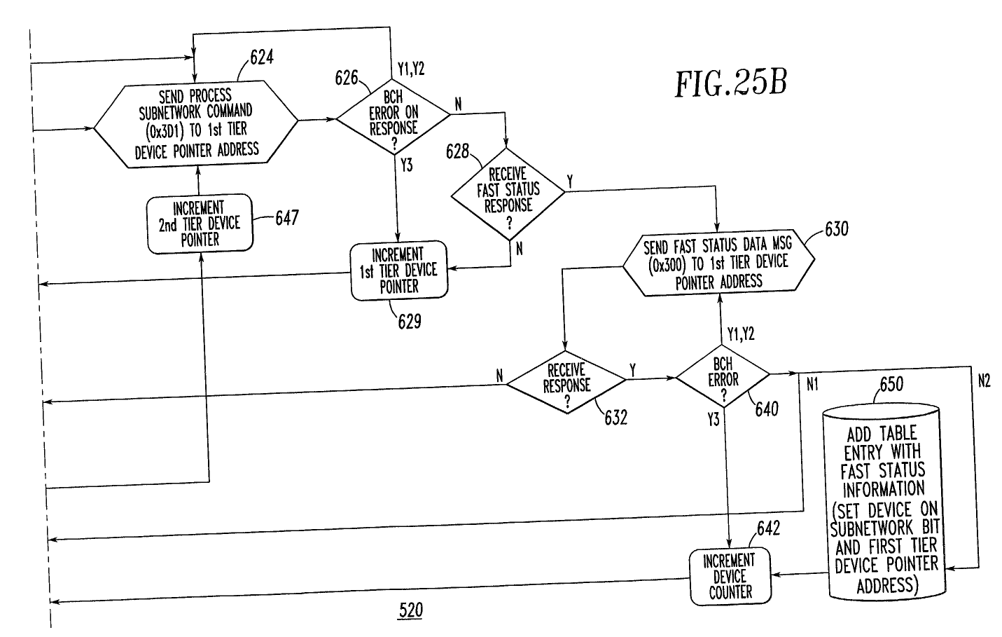

The module 2′ acts as a gateway and provides a wireless link from the PDA 16 to the control and distribution communicating devices 40,42. The module 2′ provides display of setpoints (FIG. 12), metered values (FIG. 11) and product remote control (FIG. 14) via the PDA 16. Data “Snapshots” in the messages 50 originating from the control and distribution communicating devices 40,42 are preferably time-stamped and stored in the non-volatile memory 38 (FIG. 2) of the PDA 16 for off-line review. No pre-configuration is required and automatic address scans (FIGS. 23 and 25A-25B) are employed to obtain lists of the communicating devices 42 and 40, respectively.

In the exemplary embodiment, up to 64 devices per channel may be connected to a single module 2′. A single intuitive Palm™ application 62 is employed to retrieve, view and change parameters. A HotSync™ capability is preferably employed to download metering and setpoint information over a serial port or infrared link 63 to a data file on a computer (e.g., PC 64), which data file can be imported to spreadsheets or other programs.

For communications with the modules 2,2′, the PDA 16 is preferably located within a suitable distance (e.g., about three feet (about one meter)) in order to be in suitable range for the infrared link. The PDA 16 should also be preferably positioned in order that it is within about +/−15° of the on-axis line of the modules 2,2′. While infrared communications are occurring, the PDA 16 should remain in this position range in order to maintain the data transfer with the corresponding one of the modules 2,2′. Should the PDA 16 move out of this range during a data transfer, then a warning message is displayed to inform the user to realign the PDA 16.

As shown in FIG. 3, the gateway 56 and the devices 42 preferably form part of a motor control center 66, which is typically separated from the user and the PDA 16 by a front panel 68. The window 10 and the indicators 4,6,8 of the module 2 (FIG. 1) are accessible to the user through the front panel 68.

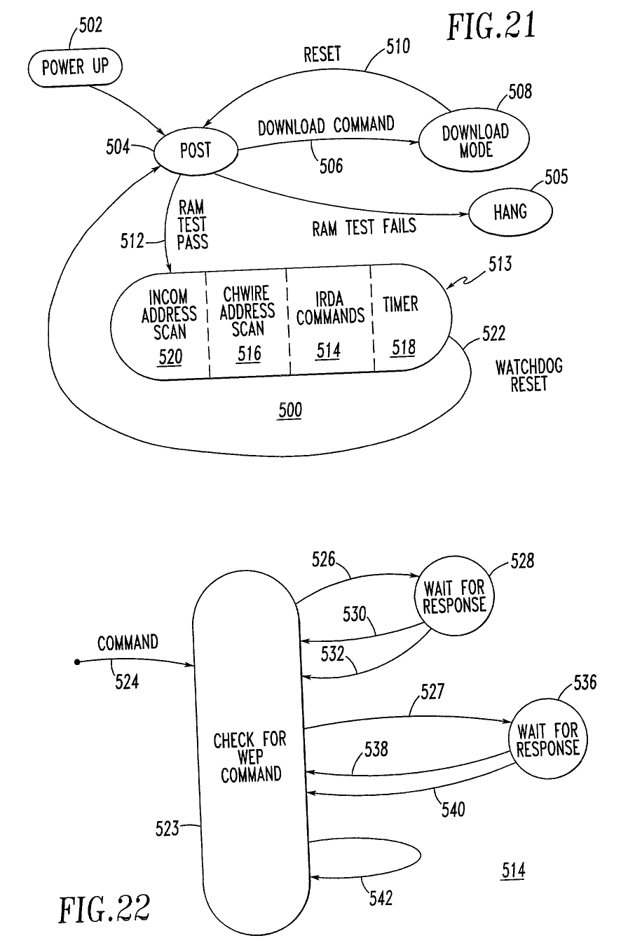

Referring to FIG. 4, the module 2′ includes a suitable microcontroller 70 having Flash/SRAM memory 72, EEPROM memory 74 and indicator drivers 76 for the three indicators 4,6,8 of FIG. 1. The module 2′ is essentially the same as the module 2 of FIGS. 1 and 2, except that the RS-232 transceiver 90 is also employed. An infrared encode-decode circuit 78 interfaces the microcontroller 70 to the infrared transceiver 12 for communication via the infrared beam 14 with the PDA 16 of FIGS. 2 and 3. As discussed below in connection with FIGS. 21-24 and 25A-25B, the microcontroller 70 employs suitable firmware in Flash 72 to pass messages (including parameters) between the PDA 16 and the devices 40,42 of FIG. 3.

The INCOM transceiver 20 drives and receives the INCOM level signals 80 based upon an INCOM transmit signal 82 from and an INCOM receive signal 84 to the microcontroller 70. In turn, the INCOM signals 80 are routed through suitable termination switch and transient protection components 86 for the INCOM connector 88.

The RS-232 transceiver 90 drives and receives the RS-232 level signals 92 based upon a transmit signal 94 from and a receive signal 96 to the microcontroller 70.

A suitable power supply 98 converts input power 100 (e.g., 120 VAC, 48 to 125 VDC, 24 VDC) to a suitable voltage 102 (e.g., +24 VDC) for the INCOM transceiver 20 and voltage regulators 104,106. In turn, the regulators 104 and 106 provide a suitable voltage 108 (e.g., +5 VDC) for the microcontroller 70 and associated circuits, and a suitable voltage 110 (e.g., +5 VDC_IR) for the infrared transceiver 12.

FIG. 5 shows the initial screen 112 of the PDA application 62 of FIG. 3, which is accessed by tapping on a PowerPDA icon (not shown) of an upper level PDA display (not shown). A list of the serial number/address (ID) 114 of the wireless transceivers (WTs) currently saved in the PDA memory 38 is displayed. For identification, each WT employs a unique address that corresponds to its manufactured serial number. The user may also search for a new WT currently within infrared range of the PDA 16. By tapping (e.g., engaging, pressing) the “Query” button 116 on the screen 112, the PDA application 62 performs a search to find any WTs in range.

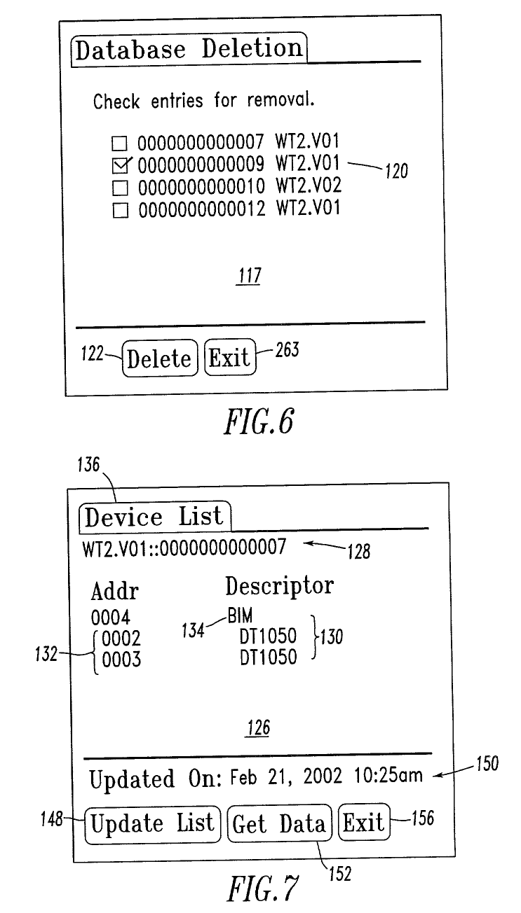

The user may access the database management screen 117 of FIG. 6 by tapping on the PowerPDA tab 118 at the top of the screen 112 and selecting Database Management from a menu (not shown). This allows the user to manually delete WTs (and the devices beneath them) from the PDA database. As shown in FIG. 6, the items (e.g., WT 120) to be removed are checked in the left column. Once the selection or selections are made, the user taps the “Delete” button 122 to clear the appropriate entries. Preferably, a confirmation pop up screen (not shown) is also employed, in order to confirm or reject the selection(s).

Referring again to FIG. 5, the user taps on the ID 114 or the Descriptor 124 for the desired WT in order to select it and see the list of devices found beneath such WT. After the chosen WT is selected, the screen 126 of FIG. 7 is displayed. The top of the screen 126 displays the descriptor and ID 128 of the currently selected WT. The PDA application 62 displays a list 130 of devices connected on the selected WT's sub-network(s). For example, devices 132 located underneath a sub-network master, such as BIM 134, are indented (as shown by the devices at addresses 0×002 and 0×003 found underneath the sub-network master at address 0×004). The user may obtain further information from these devices by tapping on them.

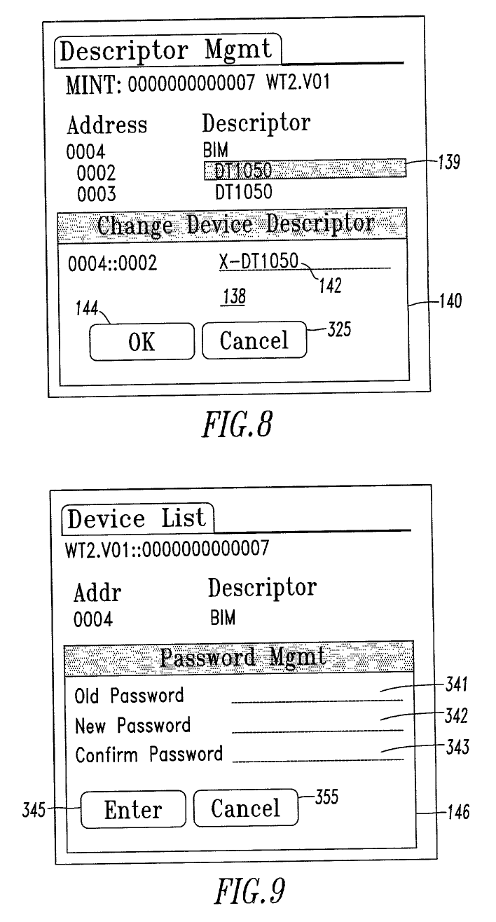

The user may edit the descriptions of any of the devices of FIG. 7 by tapping on the Device List tab 136 at the top of the screen 126 and selecting Descriptor Menu from a menu (not shown). The “Descriptor Mgmt” screen 138 of FIG. 8 allows the user to change the default descriptors given to both control and distribution devices (e.g., DT1050 139) and WTs. In response to the user tapping on the desired item to be changed, the editable dialog box 140 pops-up and displays the current descriptor 142 (e.g., DT1050). Palm Graffiti™ characters may be employed to enter the new descriptor for the devices. In turn, the user taps the “OK” button 144 to complete the entry and to return to the main “Descriptor Mgmt” screen 138, where additional changes can be made to other devices and WTs. These descriptors are stored in the PDA memory 38. The user taps the “Send List” button (not shown) of the main “Descriptor Mgmt” screen 138 to save the changes to the WT, when in range of the desired WT. After a brief confirmation (not shown), the descriptor changes are saved in that WT.

FIG. 9 shows the Password Management menu 146. The user employs the menu 146 to change a stored password in the WT, which gives access to actions such as sending setpoints and performing control actions. The default Password is: “passwd”. The user edits the password (e.g. up to six characters) in front of the desired WT, in order that the new password may be communicated over the infrared link to that WT for storage therein.

Referring again to FIG. 7, the user taps on the “Update List” button 148 to refresh the device list 130 from the selected WT, if the PDA 16 is currently within communication range of that WT. The bottom of the screen 126 displays the date and time 150 of the last list update.

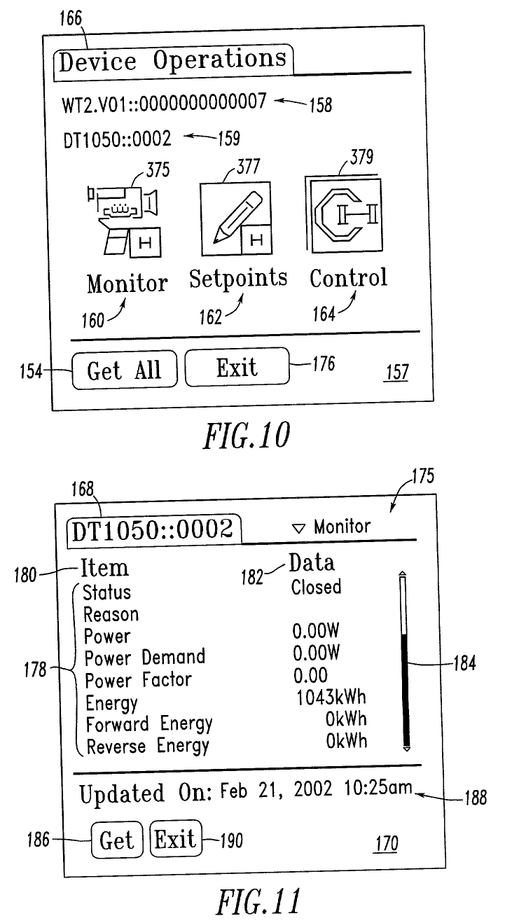

The user taps the “Get Data” button 152 to retrieve all of the information regarding the devices to the PDA 16 (including Monitor and Setpoint information). This operation may take an extended period of time depending on the type and number of devices. Shorter “connect” times may be achieved by retrieving selected data from a specific device through the “Get All” button 154 of FIG. 10. The user taps on the “Exit” button 156 of FIG. 7 to return the user to the screen 112 of FIG. 5, which displays the list of WTs in the PDA memory 38.

FIG. 10 shows the device operations screen 157 for a particular WT 158 and a particular device 159. The user initially accesses the screen 157 by tapping on a particular device in the list 132 of FIG. 7. After the user selects a device from the device list screen 126 of FIG. 7, the user may, then, choose one of three application functions: (1) Monitor 160 (FIG. 11); (2) Setpoints 162 (FIGS. 12 and 13); and (3) Control 164 (FIG. 14) as shown in FIG. 10.

The user may find general information (e.g., Address, Descriptor, Division Code, Product ID, Comm Version) about the selected device 159 by choosing “About Device” from a menu (not shown) under the “Device Operations” tab 166 of FIG. 10. In turn, a dialog box (not shown) pops-up and displays information, such as, for example, the device address, Device/Product ID Code, and Software/Comm Version. From within the three application functions 160,162,164, the tab 168 (e.g., as shown in FIGS. 11-14) in the upper left-hand corner of the corresponding screens 170,172,174, respectively, specifies the name of the selected device, which is currently being displayed. Also, a pull-down menu (not shown) from the upper right-hand corner 175 allows the user to change the display of the application function screen between the Monitor, Setpoint and Control application functions 160,162,164. The user taps the “Get All” button 154 of FIG. 10 in order to retrieve all of the available information for the selected device 159. The user taps the “Exit” button 176 to return to the device list screen 126 of FIG. 7.

FIG. 11 shows the main screen 170 of the Monitor application function 160. This screen provides the user with a list 178 of measured data values stored by the selected device 159 as shown by the tab 168. The list 178 includes both item descriptions 180 and data values 182. The list 178 may be navigated by using the scroll bar 184 located on the right-hand side of the screen 170. The user taps on the “Get” button 186 to refresh the data values 182 of the items in the list 178 from the selected device 159 via the selected WT 158 of FIG. 10. The screen 170 displays the date and time 188 of the last update near the bottom thereof. The user taps the “Exit” button 190 to return to the application function selection screen 157 of FIG. 10.

FIG. 12 shows the main screen 172 of the Setpoints application function 162. This screen displays a list 192 of the setpoints supported by the selected device 159 of FIG. 10. The list 192 includes both item descriptions 193 and data values 194. This screen 172 may be navigated in a similar manner as the screen 170 of FIG. 11 by employing the scroll bar 195 on the right-hand side thereof. The user taps the “Get” button 196 to retrieve an updated list of setpoints from the selected device 159 via the selected WT 158. This overwrites the current set of setpoints residing in the PDA memory 38. The user taps the “Send” button 198 to send the displayed set of setpoints back to the selected device 159. The screen 172 displays the date and time 200 of the last setpoint update near the bottom thereof. The user taps the “Exit” button 202 to return to the application function selection screen 157 of FIG. 10.

The user taps on a particular setpoint (e.g., LongDelay Time 204) to display the “Change Setpoint” dialog box 206 of FIG. 13. This box allows the user to make suitable changes to the selected setpoint between a minimum value (corresponding to button 208) and a maximum value (corresponding to button 210). Some of the setpoints in the list 192 of FIG. 12 may have interdependencies, which may cause the data values 194 or range limits of other setpoints to change. In some cases, a warning screen (not shown) will be displayed. In other cases, the setpoint data value 212 may be “blanked out,” which invites the entry of a new value. The setpoint data value 212 may be adjusted by increase and decrease buttons 214,216 and by fast increase and fast decrease buttons 218,220. After the data value 212 is suitably adjusted, the user taps the “OK” button 221 to return to the screen 172 of FIG. 12 with the adjusted data value. Otherwise, the user taps the “Cancel” button 222 to return to the screen 172 with the original data value. The dialog box 206 for other setpoints (e.g., LongDelayAction 223) may include a menu of possible selections (e.g., OFF, TRIP, NONE).

FIG. 14 shows the main screen 174 of the Control application function 164. This screen displays a list 224 of functions that the user may perform by tapping on the desired action. In response, the PDA 16 displays a confirmation dialog box (not shown), in order to confirm that the desired action is to be taken. For example, if the “Reset trip” control action 230 is selected, the confirmation dialog box displays the text “Are you sure that you want to Reset trip?” along with a “Yes” button to confirm the selection and a “No” button to cancel the selection. The Control screen 174 may be navigated in a similar manner as the Monitor screen 170 of FIG. 11 by employing the scroll bar 226 on the right-hand side thereof, in order to scroll or page through the list 224. The user taps on the “Exit” button 228 to return to the application function selection screen 157 of FIG. 10.

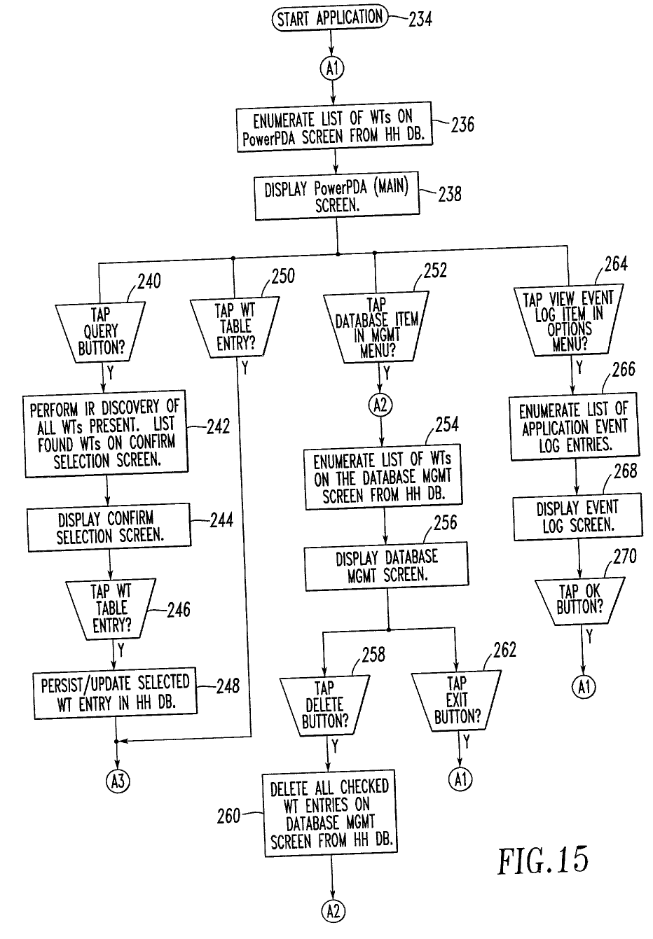

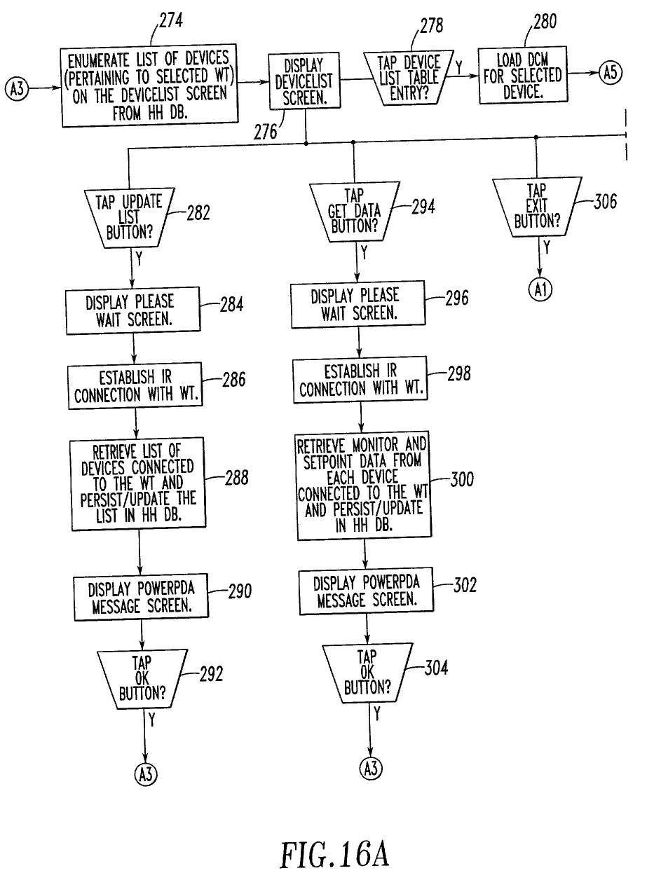

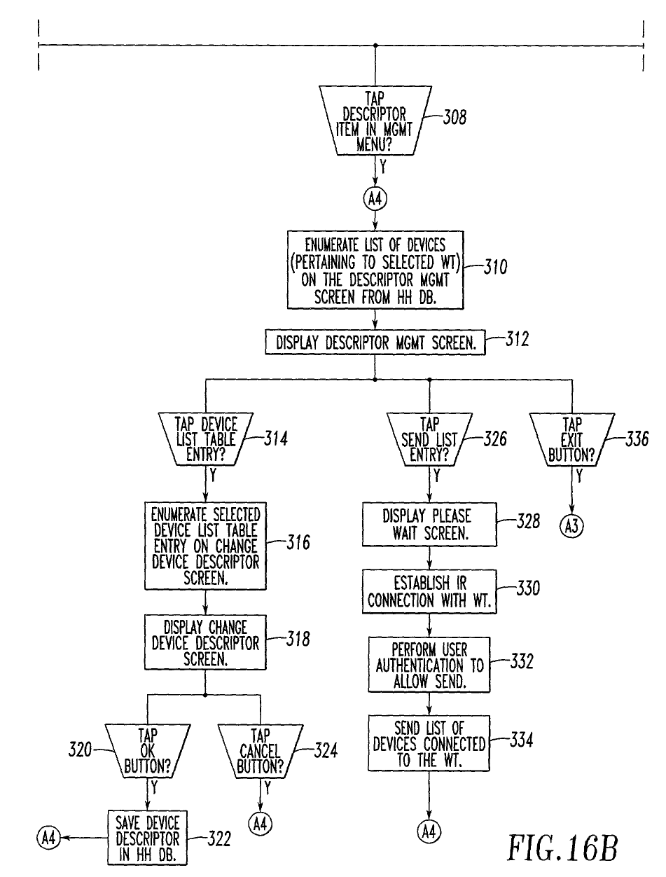

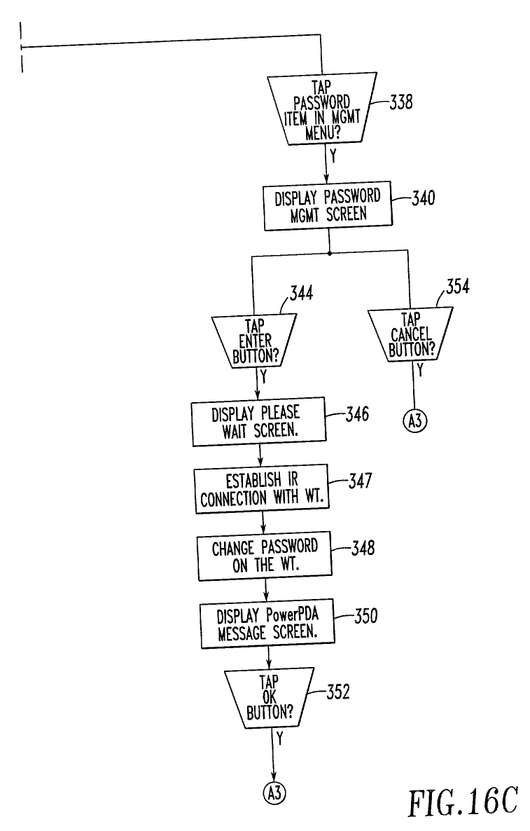

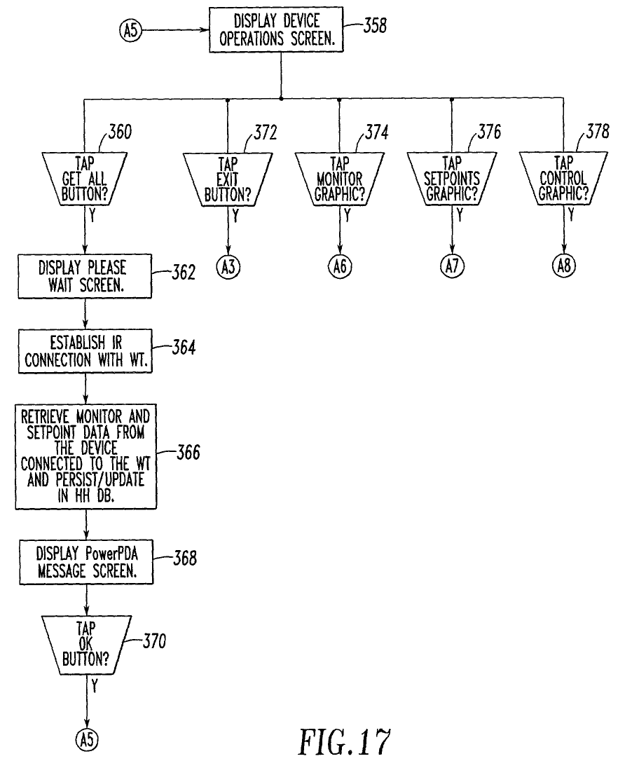

FIGS. 15-20 are flowcharts of the PDA application 62 of FIG. 3. The PDA application 62 starts, at 234, and enumerates, at 236, a list of known WTs from the database in PDA memory 38. Then, at 238, the screen 112 of FIG. 5 is displayed. Steps 240, 250, 252 and 264 detect user actions from the screen 112. At 240, it is detected if the user taps the “Query” button 116. In response, at 242, the PDA application 62 performs a search to find any WTs in range. For example, the application 62 performs infrared discovery of all WTs present (e.g., zero, one or more WTs depending upon the position of the WT(s) and the PDA 16). In turn, a list of found WTs is displayed on a confirm selection screen (not shown) at 244. Step 246 detects if the user taps on a particular WT table entry (not shown). If so, then at 248, that particular WT is added in the list of known WTs in the database in PDA memory 38. When product data is received by the PDA application 62, it is stored in the nonvolatile database in PDA memory 38 (e.g., such data is retained and persists even if the application is exited, in order that it is still available when restarting the application). In turn, execution resumes at step 274 of FIG. 16A. Similar to step 240, step 250 detects if the user taps on a particular WT table entry on the screen 112 of FIG. 5. If so, then execution resumes at step 274 of FIG. 16A.

Step 252 detects if the user wishes to access the database management screen 117 of FIG. 6 by tapping on the PowerPDA tab 118 at the top of the screen 112 and selecting Database Management from a menu (not shown). If so, then at 254, the PDA application 62 enumerates a list of WTs for the screen 117 from the database in PDA memory 38, and displays the screen 117, at 256. Step 258 detects if the user taps the “Delete” button 122. If so, then all checked WT entries on the database management screen 117 are deleted from the PDA database at 260, and execution resumes at step 254. Otherwise, step 262 detects if the user taps on the “Exit” button 263 and, if so, then execution resumes at 236.

Step 264 detects if the user wishes to access an event log (not shown) by tapping on the PowerPDA tab 118 at the top of the screen 112 of FIG. 5 and selecting Event Log from an options menu (not shown). If so, then at 266, the PDA application 62 enumerates a list of application event log entries, and displays an event log screen (not shown) at 268. Step 270 detects if the user taps on an “OK” button (not shown). If so, then execution resumes at step 236.

Following steps 248 or 250 of FIG. 15, the PDA application 62 enumerates, at 274, a list of devices (pertaining to the selected WT) for the Device List screen 126 of FIG. 7 from the database in PDA memory 38, and displays the screen 126 at 276. Steps 278, 282, 294, 306, 308 and 338 detect user actions from the screen 126. At 278, it is detected if the user taps a particular device table entry in the list 130. If so, then the device control module (DCM) (e.g., a device driver) is loaded for the selected device, at 280, after which execution resumes at step 358 of FIG. 17.

At 282, it is detected if the user taps the “Update List” button 148 of FIG. 7. If so, then a “please wait screen” (not shown) is displayed at 284, an infrared connection is established with the selected WT at 286, a list of devices connected to the WT is retrieved and the corresponding list in the PDA database in PDA memory 38 is updated at 288. Next, at 290, a “PowerPDA message screen” (not shown) is displayed. At 292, it is detected if the user taps an “OK” button (not shown) and, if so, execution resumes at 274.

At 294, it is detected if the user taps the “Get Data” button 152 of FIG. 7. If so, then a “please wait screen” (not shown) is displayed at 296, and an infrared connection is established with the selected WT at 298. At 300, Monitor and Setpoint data is retrieved from each of the devices connected to the selected WT. Next, at 302, a “PowerPDA message screen” (not shown) is displayed. At 304, it is detected if the user taps an “OK” button (not shown) and, if so, execution resumes at 274.

At 306, it is detected if the user taps the “Exit” button 156 of FIG. 7. If so, then execution resumes at 236 of FIG. 15.

Step 308 detects if the user wishes to access the descriptor management screen 138 of FIG. 8 by tapping on the Device List tab 118 at the top of the device list screen 126 and selecting Descriptor from a management menu (not shown). If so, then at 310, the PDA application 62 enumerates a list of devices (pertaining to the selected WT) for the descriptor management screen 138 of FIG. 8 from the database of the PDA memory 38, and displays the screen 138 at 312.

Steps 314, 326 and 336 detect user actions from the screen 138 of FIG. 8. Step 314 detects if the user taps one of the devices from the screen 138. If so, then at 316, the PDA application 62 enumerates the selected entry for the pop up change device descriptor screen 140, and displays that screen at 318. Step 320 detects if the user taps the “OK” button 144 and, if so, saves the new device descriptor entry 142 in the database of the PDA memory 38 at 322. In turn, execution resumes at step 310. Otherwise, step 324 detects if the user taps the “Cancel” button 325 and, if so, discards any new device descriptor entry 142 before execution resumes at step 310.

At 326, it is detected if the user taps the “Send List” button (not shown) of FIG. 8. If so, then a “please wait screen” (not shown) is displayed at 328, and an infrared connection is established with the selected WT at 330. At 332, user authentication is performed. Here, the PDA application 62 requests the stored password from the WT and compares that with the last password entered by the user. If the user has not entered a password, then the PDA application 62 requests entry of a password from a pop up screen (not shown). If the last password or the newly entered password does not match the stored password from the WT, then the pop up screen may be redisplayed. If, however, the proper password is not entered, then execution resumes at step 310, therebybypassing step 334. Otherwise, at step 334, the list of devices connected to the WT (including the new descriptor(s)) is sent to the WT before execution resumes at 310.

At 336, it is detected if the user taps the “Exit” button (not shown) of FIG. 8. If so, then execution resumes at 274.

Step 338 detects if the user wishes to access the password management pop up screen 146 of FIG. 9 by tapping on the Device List tab 118 at the top of the device list screen 126 of FIG. 7 and selecting Password from a management menu (not shown). If so, then at 340, the screen 146 is displayed. In turn, the user may enter the old password 341, a new password 342, and a confirmation password 343 on the screen 146. Step 344 detects if the user taps the “Enter” button 345. If so, then a “please wait screen” (not shown) is displayed at 346, an infrared connection is established with the selected WT at 347, and the password is changed on the WT (if the old password 341, which was entered by the user, matches the password stored in the WT, and if the new password 342 and the confirmation password 343 match each other) at 348. Next, at 350, a “PowerPDA message screen” (not shown) is displayed. At 352, it is detected if the user taps an “OK” button (not shown) and, if so, execution resumes at 274. Otherwise, step 354 detects if the user taps the “Cancel” button 355 and, if so, the new password 342 is discarded before execution resumes at 274.

Referring to FIG. 17, step 358 displays the device operations screen 157 of FIG. 10 for the selected WT 158 and the selected device 159. Steps 360, 372, 374, 376 and 378 detect user actions from the screen 157. At 360, it is detected if the user taps the “Get All” button 154 of FIG. 10. If so, then a “please wait screen” (not shown) is displayed at 362, and an infrared connection is established with 25 the selected WT at 364. At 366, Monitor and Setpoint data is retrieved from the selected device connected to the selected WT. Also, that data is updated in the database in PDA memory 38. Next, at 368, a “PowerPDA message screen” (not shown) is displayed. At 370, it is detected if the user taps an “OK” button (not shown) and, if so, execution resumes at 358.

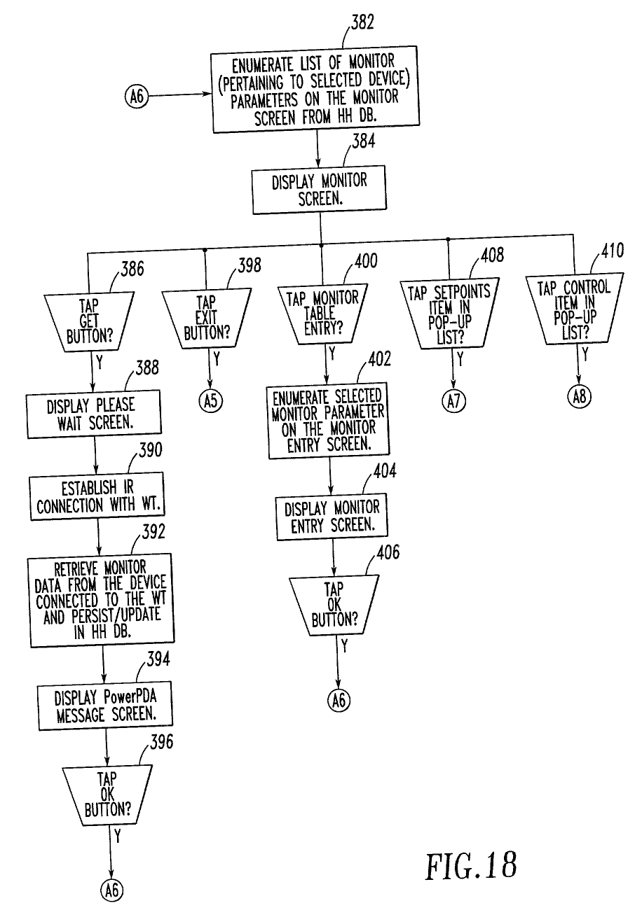

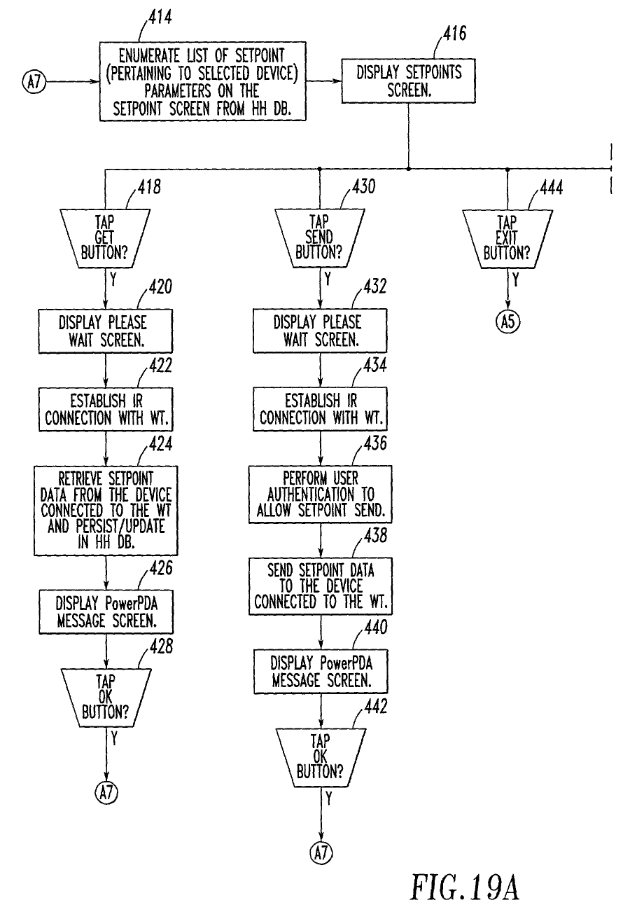

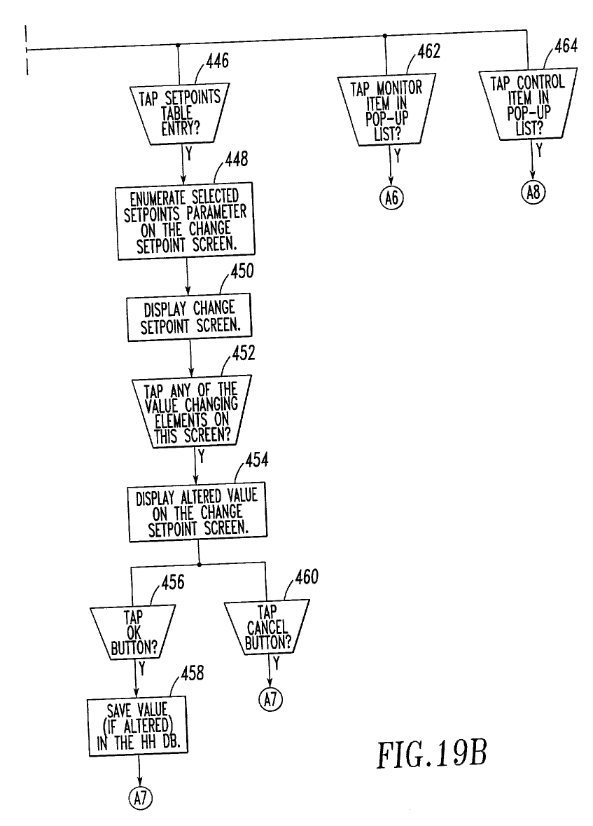

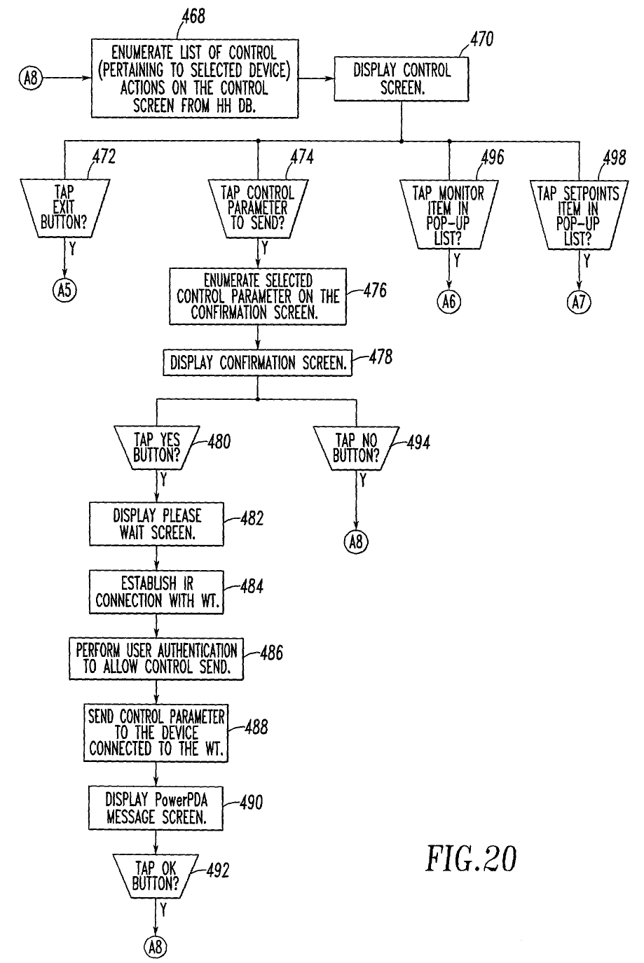

At 372, it is detected if the user taps the “Exit” button 176 of FIG. 10. If so, then execution resumes at 274 of FIG. 16A. Steps 374, 376 and 378 detect if the user taps one of the graphics 375, 377 and 379 of FIG. 10 and, if so, then execution resumes at 382 of FIG. 18, 414 of FIG. 19A, or 468 of FIG. 20, respectively.

Referring to FIG. 18, the PDA application 62 enumerates, at 382, a list of Monitor parameters (pertaining to the selected device) for the Monitor screen 170 of FIG. 11 from the database in PDA memory 38, and displays the screen 170 at 384. Steps 386, 398, 400, 408 and 410 detect user actions from the screen 170. At 386, it is detected if the user taps the “Get” button 186 of FIG. 11. If so, then a “please wait screen” (not shown) is displayed at 388, an infrared connection is established with the selected WT at 390, and Monitor data is retrieved from the selected device connected to the selected WT and the PDA database in PDA memory 38 is updated at 392. Next, at 394, a “PowerPDA message screen” (not shown) is displayed. At 396, it is detected if the user taps an “OK” button (not shown) and, if so, execution resumes at 382.

At 398, it is detected if the user taps the “Exit” button 190 of FIG. 11. If so, then execution resumes at 358 of FIG. 17.

Step 400 detects if the user taps on one of the entries in the list 178 of FIG. 11. If so, then, at 402, the selected monitor parameter is fully enumerated for a pop up screen (not shown), which is displayed at 404. At 406, it is detected if the user taps an “OK” button (not shown) and, if so, execution resumes at 382.

Steps 408 and 410 detect if the user taps a corresponding one of a Setpoints item or a Control item, respectively, from a pop up list at the upper right 175 corner of the screen 170. If so, then execution resumes at 414 of FIG. 19A, or 468 of FIG. 20, respectively.

Referring to FIGS. 19A-19B, the PDA application 62 enumerates, at 414, a list of Setpoint parameters (pertaining to the selected device) for the Setpoint screen 172 of FIG. 12 from the database in PDA memory 38, and displays the screen 172 at 416. Steps 418, 430, 444, 446, 462 and 464 detect user actions from the screen 172. At 418, it is detected if the user taps the “Get” button 196 of FIG. 12. If so, then a “please wait screen” (not shown) is displayed at 420, an infrared connection is established with the selected WT at 422, and Setpoint data is retrieved from the selected device connected to the selected WT and the PDA database in PDA memory 38 is updated at 424. Next, at 426, a “PowerPDA message screen” (not shown) is displayed. At 428, it is detected if the user taps an “OK” button (not shown) and, if so, execution resumes at 414.

At 430, it is detected if the user taps the “Send” button 198 of FIG. 12. If so, then a “please wait screen” (not shown) is displayed at 432, and an infrared connection is established with the selected WT at 434. At 436, user authentication is performed similar to step 332 of FIG. 16B. If the proper password is not entered, then execution resumes at step 414, thereby bypassing step 438. Otherwise, at step 438, the Setpoint data is sent to the selected device connected to the selected WT. Next, at 440, a “PowerPDA message screen” (not shown) is displayed. At 442, it is detected if the user taps an “OK” button (not shown) and, if so, execution resumes at 414.

At 444, it is detected if the user taps the “Exit” button 202 of FIG. 12. If so, then execution resumes at 358 of FIG. 17.

At 446, it is detected if the user taps one of the Setpoints in the list 192 of FIG. 12. If so, then the selected Setpoints parameter is enumerated for the Change Setpoint screen 206 of FIG. 13, and the screen 206 is displayed at 450. Step 452 detects if the user taps on any of the value changing elements (e.g., 208,210,214,216,218,220 of FIG. 13) and, if so, displays the adjusted Setpoint value (e.g., 212 of FIG. 13) on the screen 206 at 454. Step 456 detects if the user taps on the “OK” button 221 of FIG. 13. If so, then at 458, the Setpoint value (if adjusted) is saved in the database of the PDA memory 38, before execution resumes at 414. This allows, for example, editing of the Setpoint values in the PDA memory 38, with the possibility of later downloading to selected devices (e.g., at even steps 430-442). Otherwise, if the user taps on the “Cancel” button 222 of FIG. 13, then the adjusted Setpoint value is discarded and execution resumes at 414.

Steps 462 and 464 detect if the user taps a corresponding one of a Monitor item or a Control item, respectively, from a pop up list at the upper right 175 corner of the screen 172. If so, then execution resumes at 382 of FIG. 18, or 468 of FIG. 20, respectively.

Referring to FIG. 20, the PDA application 62 enumerates, at 468, a list of Control actions (pertaining to the selected device) for the Control screen 174 of FIG. 14 from the database in PDA memory 38, and displays the screen 174 at 470. Steps 472, 474, 496 and 498 detect user actions from the screen 174. At 472, it is detected if the user taps the “Exit” button 228 of FIG. 14. If so, then execution resumes at 358 of FIG. 17.

Step 474 detects if the user taps one of the control parameters from the list 224 of FIG. 14. If so, then at 476, the PDA application 62 enumerates the selected control parameter for a pop up confirmation screen (not shown), which is displayed at 478. Steps 480 and 494 detect user actions from that screen. Step 480 detects if the user taps an “OK” button (not shown). If so, then a “please wait screen” (not shown) is displayed at 482, and an infrared connection is established with the selected WT at 484. At 486, user authentication is performed similar to step 332 of FIG. 16B. If the proper password is not entered, then execution resumes at step 468, thereby bypassing step 488. Otherwise, at step 488, the Control action is sent to the selected device connected to the selected WT. Next, at 490, a “PowerPDA message screen” (not shown) is displayed. At 492, it is detected if the user taps an “OK” button (not shown) and, if so, execution resumes at 468. Otherwise, step 494 detects if the user taps a “No” button (not shown), which discards the proposed control action before execution resumes at step 468.

Steps 496 and 498 detect if the user taps a corresponding one of a Monitor item or a Setpoints item, respectively, from a pop up list at the upper right 175 corner of the screen 174. If so, then execution resumes at 382 of FIG. 18, or 414 of FIG. 19A, respectively.

Referring to FIGS. 21-24 and 25A-25B, the main loop 500 of the WT module microcontroller 70 of FIG. 4 functions to pass commands from the PDA 16 to the INCOM channel 44 or to the CH-Wire RS-232 channel 46. Following power up, at 502, a power up and self test (POST) routine 504 is executed. During this time, the Unit Status indicator 4 of FIG. 1 remains ON. In response to a download command “GOPROG” 506 from the RS-232 Rx signal (92 of FIG. 4) during this time, the main loop 500 enters a download mode 508. During this mode, the microcontroller 70 accepts updates of its program in Flash 72 from a personal computer (PC) (not shown) through the RS-232 transceiver 90. The download mode 508 exits in response to a hardware reset 510, which returns execution to the POST routine 504. In response to the passage of a self test of the Flash/SRAM memory 72 of FIG. 4, at 512, a set of routines is executed, preferably in parallel (e.g., time-sliced, multi-tasked), at 513. Those routines include a routine 514 of FIG. 22 for processing PDA commands, a routine 516 of FIG. 23 for processing a CH-Wire address scan, a routine 518 of FIG. 24 for processing an internal timer, and a routine 520 of FIGS. 25A-25B for processing an INCOM address scan. If, however, the memory test fails, then the three indicators 4,6,8 are turned on, and the module 2 enters a “hang” state 505.

FIG. 22 shows the routine 514 for processing commands from the PDA 16 of FIG. 2. A function 523 checks for a wireless enabled product (WEP) command 524 from the PDA 16. The command 524 may either correspond to a request 526 for the INCOM channel 44 or a request 527 for the CH-Wire RS-232 channel 46. During the processing of the command 524, the microcontroller 70 turns on the Wireless Status indicator 8. The indicator 8 is turned off when the PDA 16 indicates that the data transfer is complete and the connection is closed. In response to the INCOM channel request 526, a corresponding command is sent on the INCOM channel 44, and the microcontroller 70 turns on the Sub-Network Status indicator 6 while transmitting. Step 528 waits for a response from the INCOM channel 44. At 530, in response to an INCOM response, the corresponding response is returned to the PDA 16. Otherwise, after a suitable delay (e.g., 150 ms), a timeout occurs, and at 532, the microcontroller 70 returns to the “Check for WEP Command” state 523.

In response to the CH-Wire RS-232 channel request 527, a corresponding command is sent on the CH-Wire RS-232 channel 46, and the microcontroller 70 turns on the Sub-Network Status indicator 6 while transmitting. Step 536 waits for a response from the CH-Wire RS-232 channel 46. At 538, in response to a CH-Wire RS-232 response, the corresponding response is returned to the PDA 16. Otherwise, after a suitable delay (e.g., 60 ms), a timeout occurs, and at 540, the microcontroller 70 returns to the “Check for WEP Command” state 523.

Finally, the function 523 checks for a password request 542 from the PDA 16 and provides a suitable response thereto. The password request 542 may either be an inquiry for the value of the password (e.g., for the PDA application 62 to ensure that the user is authorized to write a value to a device or perform a control action to a device) or, a request to change the value of the password in the WT (e.g., for the PDA application 62 to modify the password).

Referring to FIG. 23, the routine 516 processes the CH-Wire address scan. An idle state function 546 checks for a CH-Wire address scan request 544 from the PDA 16. In response, a request 548 is issued to the CH-Wire gateway 56 of FIG. 3 for the number of entries in the CH-Wire Registry (i.e., its list of devices 42). Step 550 waits for a response from the CH-Wire gateway 56. If no response is received within a predetermined timeout period (e.g., 20 s), then a timeout response 551 is returned. Otherwise, if the response from the CH-Wire gateway 56 includes the same number of entries for the present request as were returned for the previous request, then no action is required at 552. On the other hand, if the response from the CH-Wire gateway 56 includes a different number of entries for the present request than were returned for the previous request, then execution transitions at 554 to step 556. This step requests the additional Registry entries and builds a corresponding entry in the address table for each new device. At 558, if all the new entries are not processed, then the next entry is requested. Finally, at 560, the complete response from the CH-Wire gateway 56 is returned with the proper number of entries for the present request.

FIG. 24 shows the routine 518 for processing an internal timer. A timer interrupt 562 triggers an idle state function 564, which generates various timers (e.g., 0.5 s, 20 s) for use by the microcontroller 70. In particular, a 0.5 s timer 566 is employed to toggle the Unit Status indicator 4 of FIG. 1. As shown in FIG. 21, a watchdog reset 522 causes execution to resume at the POST routine 504.

FIGS. 25A-25B show the routine 520 for processing the INCOM address scan. The routine 520 starts, at 602, and scans the first tier (e.g., INCOM network 18 of FIG. 2) INCOM addresses (e.g., 0×000 to 0×FFF) with the address counter set to 0×000 and the device counter set to 0. At 604, an INCOM fast status command (0×300) is sent to the INCOM device at the address counter. Next, at 606, it is determined if an INCOM response is received. If so, then at 608, it is determined if a BCH error occurred in the INCOM response. If no, then an entry is added to the address table including the fast status information (e.g., product ID; software version) at 610. At 612, the device counter is incremented. Then, at 614, it is determined if the device counter is equal to the maximum number of devices (e.g., 64). If not, then at 616, it is determined if the address counter is equal to a limit (e.g., 0×FFF). If not, then the address counter is incremented, at 618, and step 604 is repeated. At 608, if there was a BCH error (at Y1 and Y2), then step 604 is repeated two times (thereby giving three attempts at the particular address). On the third BCH error (at Y3) of step 608, or if a timeout (N) is detected at step 606, then step 616 is executed.

Otherwise, at 616, if the address counter is equal to the limit, then the first tier address scan is complete and execution resumes at step 620, which determines if the device counter is greater than zero. If so, then the first tier scan is complete. Step 622 scans the second tier INCOM addresses (e.g., those addresses, which were entered at step 610, from the first tier scan) with the address counter set to 0×000 and the first tier device pointer set to the first table entry of step 610. Then, at 624, an INCOM Process SubNetwork command (0×3D1) is sent to the first tier device pointer address. Next, at 626, it is determined if a BCH error occurred in the INCOM response. If not, then at 628, it is determined if a fast status response was received. If such a fast status response was received, then at 630, a fast status data message (0×300) is sent to address of the first tier device pointer. Next, at 632, it is determined if an INCOM response is received. If not (e.g., a timeout occurs due to the first tier device not responding), then the first tier device pointer is incremented at 634.

At 626, if there was a BCH error (at Y1 and Y2), then step 624 is repeated two times (thereby giving three attempts at the particular address). On the third BCH error (at Y3) of step 626, step 629 is executed, in order to move to the next device.

If no fast status response was received at 628 (e.g., a NACK is received; a timeout occurs if the device is not a SubNetwork master; a timeout occurs if the device no longer exists, is disconnected, or is powered down), then at 629 the first tier device pointer is incremented before step 636 is executed.

Step 636, which follows one of steps 629 and 634, determines if the first tier device pointer entry's “Device on Subnetwork” bit was set (at 650) or if the end of the portion of the table that contains first tier devices has been reached. If so, then the second tier network scan is complete, and various completion actions (e.g., saving information to nonvolatile memory) are provided at 638. If the test at 636 is false, then step 624 is repeated. Also, at step 620, if the device counter is not greater than zero, then the INCOM network is empty and step 638 is executed.

If, however, an INCOM response is received at 632, then at 640, it is determined if a BCH error occurred in the INCOM response. At 640, if there was a BCH error (at Y1 and Y2), then step 630 is repeated two times (thereby giving three attempts at the particular address). On the third BCH error (at Y3) of step 640, step 642 is executed to increment the device counter, in order to move to the next second tier device. Then, at 644, it is determined if the device counter is equal to the maximum number of devices (e.g., 64). If not, then at 646, it is determined if the address counter is equal to a limit (e.g., 0×FFF). If the test of 646 is true (the SubNetwork scan is complete), then the first tier device pointer is incremented, at 634, and step 636 is executed. Otherwise, if the address counter is not equal to the limit, then at 647, the second tier address counter is incremented before step 624 is executed.

At 644, if the device counter is equal to the maximum number of devices, then the maximum number of devices is found. Step 648 provides an exemplary 20 ms delay, in order to clear the INCOM network. In turn, step 638 is executed to provide the completion actions.

If there was no BCH error at 640 and the response received at 632 was a fast status message (N2 of 640), then the table entry with the fast status information is added to the table of step 610 at 650 before the device counter is incremented at 642. That information includes the “Device on Subnetwork” bit and the first tier device pointer address. The table update at 650 includes the devices on the INCOM sub-network (e.g., sub-network 28 of FIG. 2). Otherwise, if there was no BCH error at 640 and the response received at 632 was a device not responding message (N1 of 640), then execution resumes at step 646.

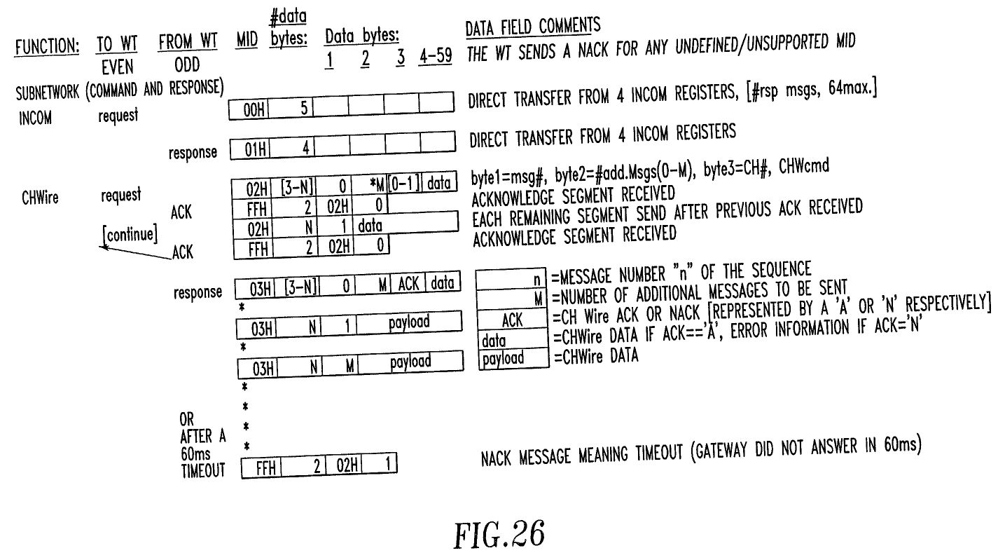

FIG. 26 shows the format of request and response messages between the PDA 16 and the module 2′ of FIG. 3 that are sent within an Infrared Data Association (IrDA) message frame.

The exemplary WT modules 2,2′ permit a plurality of electrical equipment sites to be configured with the same, similar or different operational settings as stored in the handheld PDA 16. These modules permit a program of the microcontroller 70 of FIG. 4 to be installed into such module in the field electrical equipment site by downloading from a conventional PC (e.g., a laptop PC) to the Flash memory 72 via an RS-232 port. The modules 2,2′ permit an operator to monitor electrical measurements, configure operational settings, and control electrical equipment using the infrared connection port 15 to the PDA wireless infrared port 17, the INCOM channel 44 and/or the CH-Wire RS-232 channel 46. The PDA 16 supports the upload and download of operational settings from or to a personal computer (PC), thereby permitting system design for the electrical equipment on a PC at an office and subsequent configuration of that electrical equipment at a remote field installation site. The wireless ports 17 and 15 of the respective PDA 16 and modules 2,2′ permit improved electrical isolation between the user holding the PDA 16 and the electrical equipment, by communicating between the PDA 16 and the INCOM channel 44 and/or the CH-Wire RS-232 channel 46 without wires, thereby providing a higher isolation capability and affording a better sense of well being for the user.

Unauthorized access to changes in the operating parameters (e.g., setpoints and control actions) of the electrical equipment may be blocked by a password on the PDA 16. User definable device labels may be employed.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A wireless transceiver module comprising:
means for communicating with a communication network for a plurality of first communicating devices having a plurality of parameters;
means for communicating with a portable second communicating device through a wireless port; and
means for monitoring or configuring said parameters of said first communicating devices from said portable second communicating device through said wireless port.

2. The wireless transceiver module as recited in claim 1 wherein said wireless port is an infrared port; and wherein said means for communicating with a portable second communicating device includes an infrared transceiver.

3. The wireless transceiver module as recited in claim 1 wherein said communication network is an INCOM network.

4. The wireless transceiver module as recited in claim 1 wherein said communication network includes a gateway having a first RS-232 port; and wherein said means for communicating with a communication network includes a second RS-232 port communicating with the first RS-232 port.

5. The wireless transceiver module as recited in claim 1 wherein said first communicating devices include a plurality of trip units.

6. The wireless transceiver module as recited in claim 1 wherein said parameters include a plurality of measured electrical values; and wherein said means for monitoring or configuring includes means for monitoring said measured electrical values.

7. The wireless transceiver module as recited in claim 1 wherein said parameters include a plurality of setpoint values; and wherein said means for monitoring or configuring includes means for configuring said setpoint values.

8. The wireless transceiver module as recited in claim 1 wherein said means for monitoring or configuring includes means for controlling said first communicating devices.

9. A system for monitoring or configuring communicating devices, said system comprising:
a communication network for a plurality of first communicating devices having a plurality of parameters;
a portable second communicating device including a first wireless port and a memory storing at least some of said parameters; and
a wireless transceiver apparatus comprising:
a second wireless port in communication with said portable second communicating device through said first wireless port;
an interface to said communication network; and
a processor monitoring or configuring said parameters from said portable second communicating device through said first and second wireless ports.

10. The system as recited in claim 9 wherein said first and second wireless ports are infrared ports.

11. The system as recited in claim 9 wherein said communication network is an INCOM network.

12. The system as recited in claim 9 wherein said communication network includes a gateway having a first RS-232 port; and wherein said interface includes a second RS-232 port communicating with the first RS-232 port.

13. The system as recited in claim 9 wherein said parameters include a plurality of measured electrical values; and wherein said processor includes a routine monitoring said measured electrical values.

14. The system as recited in claim 9 wherein said parameters include a plurality of setpoint values; and wherein said processor includes a routine configuring said setpoint values.

15. The system as recited in claim 9 wherein said processor includes a routine controlling said first communicating devices.

16. The system as recited in claim 9 wherein said processor includes a program and an RS-232 transceiver for updating said program from a personal computer.

17. The system as recited in claim 9 wherein said first communicating devices are control and distribution devices.

18. The system as recited in claim 9 wherein said first communicating devices include a breaker interface module.

19. The system as recited in claim 9 wherein said portable second communicating device is a personal digital assistant.

20. The system as recited in claim 9 wherein said processor includes means for remotely controlling said first communicating devices from said portable second communicating device through said first and second wireless ports.
